(19) United States
(12) Patent Application Publication
(10) Pub. No.: US 2006/0075370 A1
(43) Pub. Date: Apr. 6, 2006

(54) Method and apparatus for automating post-tape release VLSI modifications

(76) Inventors: Brett H. Williams, Windsor, CO (US); Richard S. Rodgers, Fort Collins, CO (US)

Correspondence Address: AVAGO TECHNOLOGIES, INC., P.O. BOX 1920, DENVER, CO, 80201-1920, US

(21) Appl. No.: 10/950,919

(22) Filed: Sep. 27, 2004

(51) Int. Cl. G06F 9/455; G06F 17/50

(52) U.S. Cl. 716/11

(57) ABSTRACT

A method and an apparatus for automatically making changes to one or more metal layers of an IC design after the IC design has been tape released. The apparatus includes an ECO tool configured to receive a directive or a list of directives and to automatically make modifications described by the directives to one or more metal layers of the design. The ECO tool of the present invention obviates the need to make changes manually to the post-tape release design using a layout editor. The ECO tool automatically ensures that no changes are made to non-metal layers of the IC design. Therefore, once the post-tape release changes have been made, masks only need to be generated for the modified metal layers. In addition, because the ECO tool does not make changes that are not described by directives, confidence is maintained in the previously verified unchanged portions of the design.

### BACKGROUND OF THE INVENTION

Integrated circuits (ICs) are designed using very large scale integrated circuit (VLSI) techniques. FIG. 1 illustrates a flow diagram of the current VLSI design process. A placement tool 11 receives as its input a netlist 9 that defines the logical connectivity of the components of the design. It then automatically determines acceptable positions of the components. A routing tool 13 receives as its input a file from the placement tool 11 that indicates the placement of the components. Then, the routing tool 13 connects the components with conductors. Once placement and routing have been performed, one or more verification tools 15 are used to verify the completed design to ensure that the IC will function properly. Once the design has been verified, the process moves to tape release 17 where masks for the design are generated.

Often times it is necessary to make changes to the completed design after it has been released to tape and masks have been generated. Mistakes may need to be corrected and/or minor features added. Because the mask costs continue to rise, it is desirable to implement these changes while affecting as few mask layers of the chip as possible. In particular, it is common to target a “metal-only” mask change, where all of the very expensive field effect transistor (FET) layers are left unmodified. In a metal-only mask change, masks will only need to be generated for the metal layers.

It is common for a physical design to be built with potential post-tape release changes in mind. Pre-populating the physical design with spare gates reserves space and resources for implementing potential design modifications. When a post-tape release change needs to be made to the design, an engineering change order (ECO) is issued. When this occurs, the designer is required to analyze the ECO and determine how to implement the changes with minimal impact to the other elements in the design. Currently, making post-tape release changes requires that the designer investigate the physical design for a way to implement the desired change and then make the changes manually using a layout editor 19 (FIG. 1) and the aforementioned spare gates with which the design has been pre-populated. Once the changes have been made manually, the design is re-verified using the verification tools 15.

The process of making manual changes to a design using the layout editor 19 is difficult, time consuming and error prone. Furthermore, any mistake made by the designer results in the need to correct and re-verify the design. In addition, mistakes often require multiple iterations through the verification processes. In particular, when post-tape release changes are “metal-only”, it is necessary to verify that only metal layers were changed. This is an extra step that is not performed during the original design cycle of the chip. In addition, increases in the complexity and quantity of the changes that need to be made increases the possibility that the designer will make a mistake when making changes, which will require that the design be re-verified.

Accordingly, it would be desirable to automate the process of making post-tape release changes in order to decrease the amount of time required to make the changes, lower the risks associated with making mistakes when making changes, and reduce the complexity of the designer's task of making the changes manually using a layout editor.

### SUMMARY OF THE INVENTION

The present invention provides a method and an apparatus for automatically making changes to one or more metal layers of a post-tape release IC design. The present invention includes an ECO tool configured to receive a directive or a list of directives and to automatically make modifications described by the directives to one or more metal layers of the post-tape release design. The ECO tool obviates the need to make changes manually to a post-tape release design using a layout editor. The ECO tool automatically ensures that no changes are made to non-metal layers of the IC design during the placement of new gates. Therefore, once the post-tape release changes have been made, masks only need to be generated for the modified metal layers. In addition, because the ECO tool does not make changes that are not described by directives, confidence is maintained in the previously verified unchanged portions of the design.

These and other features and advantages of the invention will become apparent from the following description, drawings and claims.

### BRIEF DESCRIPTION OF THE DRAWINGS

FIG. 1 illustrates a flow diagram of the current VLSI process for designing ICs.

FIG. 2 illustrates a flow diagram of the VLSI design process modified in accordance with the present invention to allow post-tape release changes to be automatically made to an IC design.

FIG. 3 illustrates a flow chart of the method of the present invention in accordance with an embodiment for automatically performing placement on an IC design that has previously been placed, routed, verified and released to tape.

FIG. 4 illustrates a flow chart of the method of the present invention in accordance with an embodiment for locating a placement position for a design element.

### DETAILED DESCRIPTION OF THE PREFERRED EMBODIMENT

The invention allows post-tape release changes to be made automatically to a completed IC design rather than manually with a layout editor. In addition, the present invention ensures that only metal layers of the design are modified, which reduces mask costs and enables confidence to be maintained in the previously verified design of the non-metal layers (i.e., the transistor layers).

When post-tape release changes need to be made to a design, it is desirable to change only metal layers so that only masks for the metal layers need to be generated. As indicated above, because the costs of generating masks continue to increase, it is desirable to implement post-tape release changes without affecting layers other than the metal layers. The present invention ensures that post-tape release changes are only made to the metal layers. Because the present invention automates the process of making post-tape release changes, the problems associated with making errors when changes are made manually are eliminated.

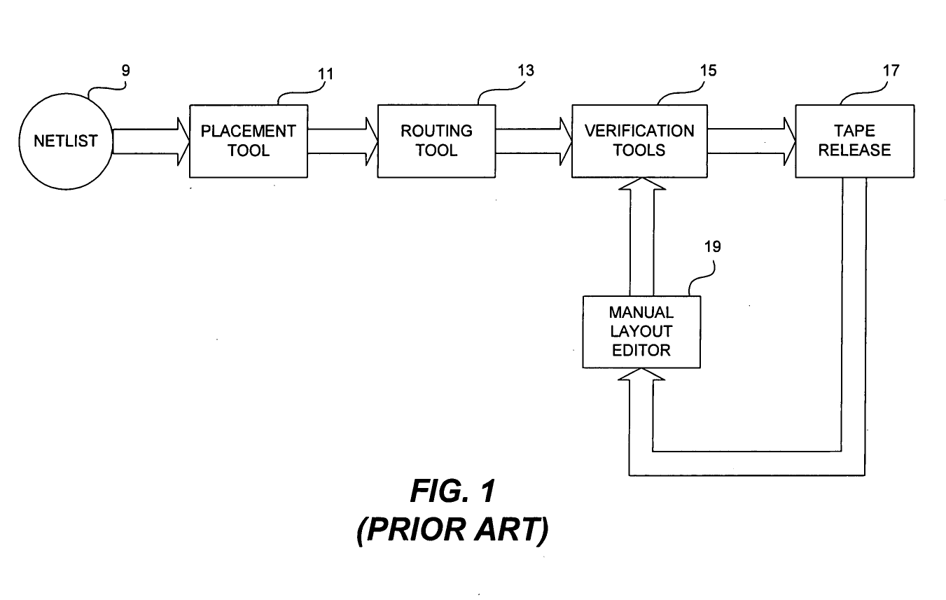

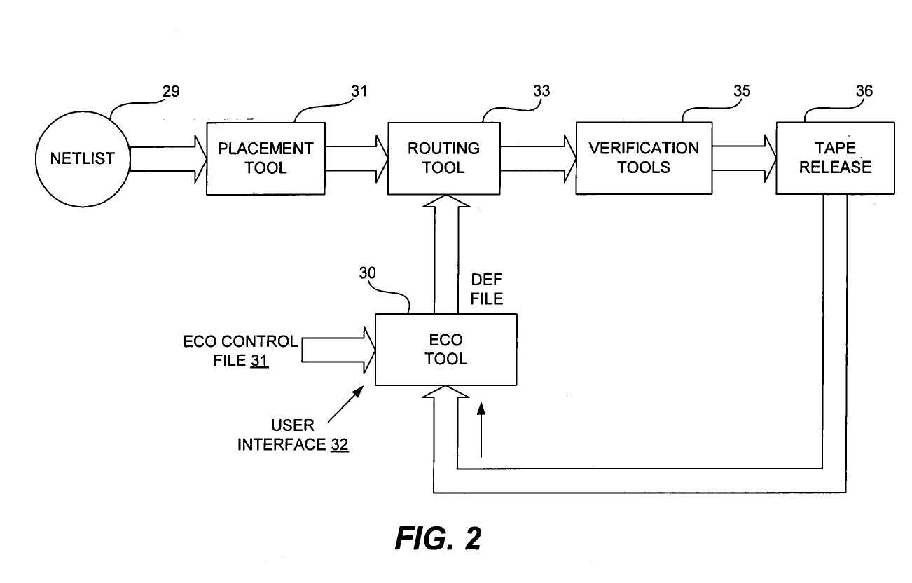

FIG. 2 illustrates a flow diagram of the VLSI design process modified in accordance with the present invention. Blocks 29, 31, 33, 35 and 36 in FIG. 2 are identical to blocks 9, 11, 13, 15 and 17, respectively, in FIG. 1. FIG. 2 does not include the layout editor 19 shown in FIG. 1 because the present invention eliminates the need to use a layout editor to manually alter a post-tape release design. Instead, the present invention provides an engineering change order (ECO) tool 30 that is capable of automatically modifying an IC design post-tape release such that only non-metal layers of the design are modified. The ECO tool 30 preferably is a software program being executed by a computer.

The ECO tool 30 modifies the logical and/or physical design only to the extent necessary in view of the changes indicated in an ECO control file 31 received by the ECO tool 30. The control file 31 is created by a designer who analyzes an engineering change order (ECO) to determine what changes need to be made to one or more metal layers of the design. The ECO tool 30 receives the control file 31 via a user interface 32 and makes the changes automatically in response to directives included in the control file 31. The ECO tool 30 minimizes changes that are made so that the existing design is impacted as little as possible. This decreases the possibility of making changes that will cause the design to fail quality checks that the design previously passed during the verification process. For example, all routes for nets that are not affected by the changes made to the metal layers preferably are left untouched by the ECO tool 30.

The directives included in the control file 31 give the designer varying levels of control over the placement of new gates. For cases where the modifications that need to be made are not complex, the designer may not need to provide the ECO tool 30 with any placement guidance. For cases where the modifications are more complex, the invention allows the designer be very explicit with respect to selecting the location of a new gate. Because the ECO tool 30 only makes placement changes as required by the directives included in the control file 31, no portions of the design other than those associated with the directives are changed. This is in contrast to typical placement tools, such as the complex placement tool 11 shown in FIG. 1, which automatically perform placement on other portions of the design when a particular placement task is performed, even when those other portions of the design are not directly affected by the changes required by the ECO.

The ECO tool 30 is configured to receive both explicit placements from the designer as well as placement “hints”. A placement hint provides a starting point from which to begin looking for a placement location. An explicit placement provides a precise location in the design for the design element to be placed. Furthermore, the ECO tool 30 of the present invention preferably automatically performs rule checking after placement to ensure that any placements were made correctly. For example, the ECO tool 30 performs rules checking to detect short circuits and ensures that routing of affected nets is performed.

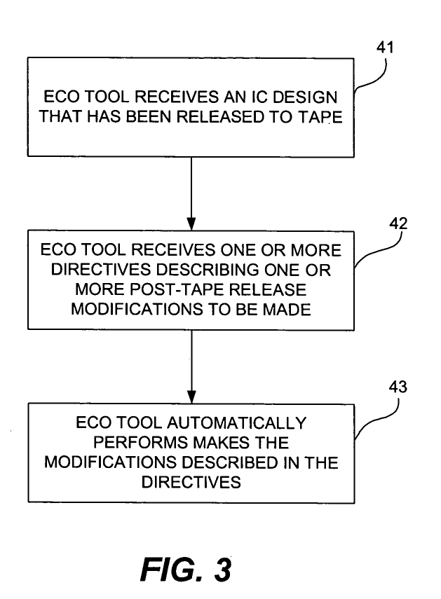

FIG. 3 illustrates a flow chart of the method of the present invention in accordance with an embodiment for automatically making one or more post-tape release changes to an IC design. The ECO tool receives an IC design that has already been released to tape, as indicated by block 41. The ECO tool also receives a control file including directives that describe tasks to be performed by the ECO tool on the IC design, possibly including directives for placement, but also possibly including changes to be made to the logical and/or physical connectivity of the design, as indicated by block 42. As indicated above, the ECO tool is configured to ensure that changes are only made to the metal layers of the design. In addition, the ECO tool preferably is configured to ensure that any gate being replaced is replaced with the same type of gate (i.e., a gate having the same logical functionality). This is because a gate of a particular type cannot be swapped out with a gate of another type without making changes to the transistor layers, i.e., the non-metal layers. The ECO tool also ensures that the gate being placed in the design has sufficient drive strength (i.e., size). Thus, the ECO tool searches the design for a fill cell that contains the same type of gate as the gate being replaced and that has sufficient drive strength. Once the ECO tool has received the control file, the ECO tool causes the tasks identified by the directives to be automatically performed, as indicated by block 43.

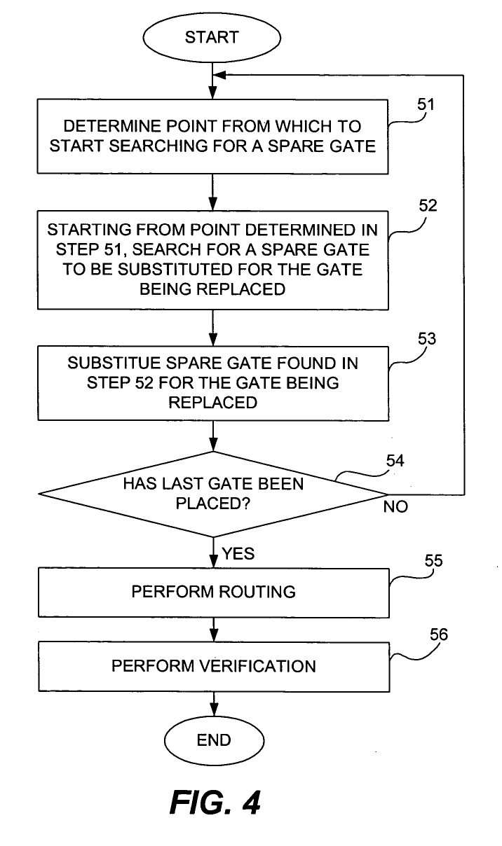

The following is a non-exclusive list of examples of directives that the designer provides as input to the ECO tool of the present invention in the form of an ECO control file. It should be noted that the present invention is not limited to the directives listed and that directives may be added or deleted from the list as desired:
1. placement_hint {instname x y}. This directive causes the ECO tool to place the specified instance near the point x, y. The ECO tool then automatically determines exactly where the specified instance will be placed using the hint as a starting point. The manner in which placement is performed by the ECO tool will be described below in more detail with reference to FIG. 4.
2. placement_hint_inst {instname hint_instname}. This directive indicates that the specified instance should be placed near the placement of the instance named ‘hint_instname’. If the hint_instname refers to a particular spare gate, this results in that particular spare gate being chosen as the one to be replaced. This directive results in the tightest control over gate placement.
3. add_connection {pin1 pin2}. This directive causes the ECO tool to add a connection between pins 1 and 2. If no net is connected to either pin, a new net will be created by the ECO tool. If both pins are already connected to different nets, this directive will result in an error.
4. disconnect {pin}. This directive causes the ECO tool 30 to disconnect a pin. This directive needs to be performed before reconnecting the pin to something else.
5. create_instance {instancename cellname}. This directive causes the ECO tool to create a new instance of the specified type (e.g., a NAND gate).
6. delete_net {netname}. This directive causes the ECO tool to delete the entire specified net, including the logical and physical models of the net.
7. delete_route {netname}. This command causes the ECO tool to delete the physical connectivity for the given net. To ensure that the net is simply rerouted without changing the logical connectivity, the delete_route directive should be used instead of the delete_net directive.
8. buffer_pin {pin buffer_type}. This directive causes the ECO tool to place a buffer near the specified pin. It handles both input and output pins. In both cases, the placement hint for the new gate defaults to the given pin.
9. create_net {netname}. This directive causes the ECO tool to create a new net.

The manner in which the ECO tool finds a placement location in accordance with an embodiment will now be described with reference to the flow chart illustrated in FIG. 4. For each new gate to be placed, the ECO tool 30 determines a “desired” point in the design at which to begin placement, as represented by block 51. If a placement “hint” has been provided by the designer by using the aforementioned placement_hint or placement_hint_inst directives, then that point is treated by the ECO tool as the “desired” point. If not, the ECO tool will calculate a reasonable placement to use as the “desired point”. In this latter case, starting at the “desired point”, the ECO tool will search for a spare gate to be substituted for the gate being replaced, as indicated by block 52. During this step, the ECO tool preferably selects the spare gate nearest to the starting point that meets the following criteria:
1. The spare gate is within a given distance, which is a parameter set by the designer; and
2. The spare gate is of the correct logical function, i.e., of the same logical function as the gate to be replaced.
3. The spare gate has sufficient drive strength.
   The spare gate found in step 52 is then substituted for the gate being replaced, as indicated by block 53. In order to enable the ECO tool to perform this step, the designer provides the ECO tool with a file that contains the legal mapping for gate types. Control over gate sizes and other parameters is made possible by this function. For example, the designer may wish to avoid smaller gate sizes due to potential long routes. After the ECO tool has made all of the gate substitutions, routing for the gates that have been substituted into the design is performed, as indicated by blocks 54 and 55. After routing has been performed, the modified design is verified, as indicated by block 56.

Preferably, routing is performed by the routing tool 33 used during the normal design process, as shown in FIG. 2. The ECO tool 30 delivers a design exchange format (DEF) file to the routing tool 33. Once routing has been performed by the routing tool 33, verification is performed on the routed design by one or more verification tools 35. Once the design has been verified, the design is sent to tape release 36. Although routing preferably is performed by the routing tool 33, the ECO tool 30 of the present invention may be configured to perform routing, in which case the output of the ECO tool 30 would be input to the verification tools 35 rather than to the routing tool 33.

As indicated above, the ECO tool of the present invention preferably does not change the placement of any gates unless instructed by the designer. Therefore, the metal layers of the design are only modified to the extent necessary to provide routing for the connections to the gates that have been substituted into the design. The non-metal layers are not modified. Consequently, only masks for the metal layers that have been modified will need to be created, which reduces the replacement mask costs. In addition, confidence in the unmodified portion of the previously verified design is maintained.

The following is an example of a naming convention for the spare gates contained in fill cells of the design:
fill3 inv_a1
fill61=inv_a4
fill4=nand2_a1
fill11=nand2_a4
fill9=xor2_a1
   The term on the left corresponds to the name of the fill cell and the term on the right corresponds to the type of gate contained in the fill cell. The spare gate and the gate to be replaced are identical except that some metal has been added to the spare gate to tie its inputs to ground or to the voltage supply. The “a1” suffix indicates that the gate is a small gate, i.e., a gate having a low drive strength. The “a4” suffix indicates that the gate is a larger gate, i.e., a gate having a higher drive strength than an “a1” gate.

Of course, this is only an example of a naming convention that can be used to identify the fill cells and the types and sizes of the gates contained in them. Any naming convention may be used for this purpose. The a1 and a4 terms are not uniform in the industry, but standard libraries have gates that are equivalent logically, but that vary in drive strength.

The following is an example of a set of gate mapping commands. The item on the left side of the statement indicates a desired gate type. The item on the right side of the statement indicates which fill cell types are allowable to fill a request to make a gate of that type.

# GATE MAPPING

set_candidates inv_a1 [list fill61 fill3]
set_candidates inv_a4 [list fill61]
set_candidates nand2_a1 [list fill11 fill4]
set_candidates nand2_a4 [list fill11]
set_candidates xor2_a1 [list fill9]
   The first statement indicates that if an inverter type gate of size a1 is needed, both of the fill cells fill61 and fill3 are suitable candidates. The second statement indicates that if an inverter type gate of size a4 is needed, fill cell fill61 is a suitable candidate. The third statement indicates that if a NAND gate of size a1 is needed, fill cells fill11 and fill3 are suitable candidates. The fourth statement indicates that if a NAND gate of size a4 is needed, fill cell fill11 is a suitable candidate. The fifth statement indicates that if an exclusive OR gate of size a1 is needed, fill cell fill9 is a suitable candidate.

The reason for allowing multiple choices for the fill cell gates is to allow a spare gate to be used even when it is not an exact match, but serves the same logical function. For example, if a request is made for inv_a1 and no inverters of size a1 are available, inv_a4 may be used. An inverter of size a4 will have more drive strength than an inverter of size a1, but that does not present a problem. The reverse is not always true. If an inv_a4 is requested, an inv_a1 is probably not strong enough. Hence, the designer does not set, for example, fill3, which is a logical equivalent to inv_a1, as a candidate for an inv_a4. If the designer made the following request:
set_candidates inv_a1 [list fill61]
set_candidates nand2_a1 [list fill11],
   then the designer would be requiring exact size matching. This works satisfactorily with the present invention. However, when the resources requested are scarce, it may make placement more difficult. For example, if there are a lot of a4 size fill cells (fill61) in the design, but they are not allowed to be used for an inv_a1 request, the design must be searched further for an a1 size (fill3).

While the present invention has been described with reference to particular embodiments, it will be understood that the present invention is not limited to these embodiments. For example, although the ECO tool of the present invention has been described as being implemented in software, it may instead be implemented as hardware or as a combination of hardware and software. Also, the ECO tool of the present invention need not perform changes in accordance with an issued ECO. The control file input to the ECO tool may include directives that are generated based on information not included in an ECO. Other variations may be made to the embodiments described herein and all such variations are within the scope of the present invention.

What is claimed is:

1. An apparatus for automatically making post-tape release changes to an integrated circuit (IC) design, the apparatus comprising:
an engineering change order (ECO) tool configured to receive at least one directive describing a modification to be made to one or more metal layers of the IC design, the ECO tool being configured to automatically make modifications to said one or more metal layers in accordance with said at least one directive received by the ECO tool.

2. The apparatus of claim 1, wherein the ECO tool only modifies the IC design to the extent necessary to accomplish said at least one directive.

3. The apparatus of claim 1, wherein the ECO tool comprises a user interface for receiving said at least one directive, said at least one directive being input to the ECO tool by a user as part of a control file, the ECO tool automatically modifying said one or more metal layers in accordance with information contained in the control file.

4. The apparatus of claim 1, wherein said at least one directive is selected from a group of directives, the group comprising:
a first directive that directs the ECO tool to search the IC design for a spare gate that performs a particular logical function, the ECO tool automatically searching the design in response to receiving the first directive and selecting a particular spare gate found during the search to be placed in the design.

5. The apparatus of claim 4, wherein the first directive directs the ECO tool to search the IC design for a spare gate in the IC design that performs a particular logical function and that has a particular size or drive strength.

6. The apparatus of claim 4, wherein the group further comprises:
a second directive that directs the ECO tool to automatically disconnect input pins of a gate being replaced in the IC design from routing in the IC design; and
a third directive that directs the ECO tool to connect routing in the IC design to input pins of a spare gate found by the ECO tool when the ECO tool performed the search.

7. The apparatus of claim 4, wherein the first directive directs the ECO tool to begin the search from a starting point in the IC design, the starting point corresponding to a particular gate in the IC design.

8. The apparatus of claim 4, wherein the first directive directs the ECO tool to begin the search from a starting point in the design, the starting point corresponding to a point at or near a location at which a particular instance is located in the design.

9. The apparatus of claim 8, wherein the particular instance corresponds to a spare gate in the IC design.

10. The apparatus of claim 4, wherein the first directive does not provide an indication to the ECO tool of a location in the design to use as a starting point for the search, and wherein the ECO tool automatically selects a reasonable location in the design from which to begin the search.

11. The apparatus of claim 1, wherein said at least one directive is selected from a group of directives, the group comprising:
a first directive that directs the ECO tool to disconnect a specified pin in the design;
a second directive that directs the ECO tool to create a new instance of a specified type in the design;
a third directive that directs the ECO tool to delete a specified net in the design;
a fourth directive that directs the ECO tool to delete a route in the design;
a fifth directive that directs the ECO tool to place a buffer near a specified pin in the design;
a sixth directive that directs the ECO tool to create a specified new net in the design;
a seventh directive that directs the ECO tool to place a specified instance near a specified point in the design;
an eighth directive that directs the ECO tool to place a specified instance near another instance in the design; and
a ninth directive that directs the ECO tool to connect a pin of a gate in the design to a net.

12. The apparatus of claim 1, wherein when said at least one directive is performed, the ECO tool generates a file that is suitable for processing by a routing tool and outputs the file to a routing tool that performs all necessary routing.

13. The apparatus of claim 1, wherein after said at least one directive has been performed, the ECO tool performs routing on the modified design.

14. A method for making post-tape release changes to an integrated circuit (IC) design, the method comprising:
in a computer, receiving a post-tape release IC design to be modified;
in said computer, receiving at least one directive describing at least one post-tape release modification to be made to an IC design; and
automatically modifying at least one metal layer of the IC design with said computer in accordance with said at least one directive.

15. The method of claim 14, wherein the IC design is only modified to the extent necessary to accomplish said at least one directive.

16. The method of claim 14, wherein said at least one directive is selected from a group of directives, the group comprising:
a first directive that directs said computer to search the IC design for a spare gate that performs a particular logical function, the computer automatically searching the design in response to receiving the first directive and selecting a particular spare gate found during the search to be placed in the design.

17. The method of claim 16, wherein the first directive directs said computer to search the IC design for a spare gate in the IC design that performs a particular logical function and that has a particular size or drive strength.

18. The method of claim 16, wherein the group further comprises:
a second directive that directs the computer to automatically disconnect input pins of a gate being replaced in the IC design from routing in the IC design; and
a third directive that directs the computer to connect routing in the IC design to input pins of a spare gate found by said computer when said computer performed the search.

19. The method of claim 16, wherein the first directive directs said computer to begin the search from a starting point in the IC design, the starting point corresponding to a particular gate in the IC design.

20. The method of claim 16, wherein the first directive directs said computer to begin the search from a starting point in the design, the starting point corresponding to a point at or near a location at which a particular instance is located in the design.

21. The method of claim 20, wherein the particular instance corresponds to a spare gate in the IC design.

22. The method of claim 20, wherein the first directive does not provide an indication to said computer of a location in the design to use as a starting point for the search, and wherein said computer automatically selects a reasonable location in the design from which to begin the search.

23. The method of claim 16, wherein said at least one directive is selected from a group of directives, the group comprising:
a first directive that directs said computer to disconnect a specified pin in the design;
a second directive that directs said computer to create a new instance of a specified type in the design;
a third directive that directs said computer to delete a specified net in the design;
a fourth directive that directs said computer to delete a route in the design;
a fifth directive that directs said computer to place a buffer near a specified pin in the design;
a sixth directive that directs said computer to create a specified new net in the design;
a seventh directive that directs said computer to place a specified instance near a specified point in the design;
an eighth directive that directs said computer to place a specified instance near another instance in the design; and
a ninth directive that directs said computer to connect a pin of a gate in the design to a net.

24. The method of claim 14, wherein when said at least one directive is performed, said computer generates a file that is suitable for processing by a routing tool and outputs the file to a routing tool that performs all necessary routing.

25. The method of claim 14, wherein after said at least one directive has been performed by said computer, said computer performs routing on the modified design.

26. A computer program for making post-tape release changes to an integrated circuit (IC) design, the program being embodied on a computer readable medium, the program comprising:
a first code segment that receives a post-tape release IC design to be modified;
a second code segment that receives at least one directive describing at least one post-tape release modification to be made to an IC design; and
a third code segment that automatically modifies at least one metal layer of the IC design in accordance with said at least one directive.

27. The computer program of claim 26, wherein the IC design is only modified by the program to the extent necessary to accomplish said at least one directive.

28. The computer program of claim 26, wherein said at least one directive is selected from a group of directives, the group comprising:
a first directive that directs said program to search the IC design for a spare gate that performs a particular logical function, the program automatically searching the design in response to receiving the first directive and selecting a particular spare gate found during the search to be placed in the design.

29. The computer program of claim 28, wherein the first directive directs the program to search the IC design for a spare gate in the IC design that performs a particular logical function and that has a particular size or drive strength.
